(19) United States
(12) Patent Application Publication
(10) Pub. No.: US 2009/0112468 A1
(43) Pub. Date: Apr. 30, 2009

(54) Method and apparatus for displaying map and vehicular navigation system

(75) Inventors: Takuya Hisano, Tokai-city (JP); Kenji Tsuji, Gifu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,714

(22) Filed: Oct. 14, 2008

(30) Foreign Application Priority Data
Oct. 29, 2007 (JP) 2007-280454

(51) Int. Cl. G01C 21/32

(52) U.S. Cl. 701/212

(57) ABSTRACT

A bird's-eye view map is drawn to have two horizontal divisions which divide the display window into three display window sections. The top display window section displays an image of a bird's-eye view in which a mountain range in the distant-range view is drawn using altitude information as it is. The central display window section displays a bird's-eye view in which a mountain range is drawn using altitude information by 50%. In addition, the bottom display window section displays a bird's-eye view in which a road or the like in the close-range view is drawn without using altitude information. This configuration of the whole of the display window can provide a bird's-eye view map with reality. Further, the road or the like in the close-range view is drawn with depression and projection not so highly conspicuous. Users can be thus provided with a bird's-eye view map having enhanced visibility.

### CROSS REFERENCE TO RELATED APPLICATION

This application is based on and incorporates herein by reference Japanese Patent Application No. 2007-280454 filed on Oct. 29, 2007.

### FIELD OF THE INVENTION

The present invention relates to a technology to display a bird's-eye view map in a vehicular navigation system.

### BACKGROUND OF THE INVENTION

A navigation apparatus is typically required to display a map having a good appearance or visibility as one of the important specifications. To improve the appearance of the display map, a bird's-eye view map is used in the map display. The bird's-eye view map expresses a view obliquely seen from a fixed height as a view point. This can provide a driver with more real information.

Many of bird's-eye view display technologies put in practical use show a map in a flat map or two-dimensional manner. For example, an image of a mountain range is displayed in a distant-range view. A display window is divided into two sections. Herein, for securing easy visibility, the lower window section displays a two dimensional map while the upper window section displays a bird's-eye view. Such a bird's-eye view is drawn only as a flat map.

In contrast, in order to execute still more real expression, there is a technology to express a mountain range and a height of a building in a land area. In such a technology, a map is divided into meshes. Each mesh is defined with altitude information and a polygon is generated based on the altitude information for each mesh. A three-dimensional map display can be thus realized. Herein, in order to express the three-dimensional map with reality, it is necessary to draw the map by using a great deal of polygons resulting from making the meshes finer as much as possible. This increases proportionally processing load in the drawing and leads to the deterioration of performance (e.g., writing speed), thus posing a problem.

Patent document 1 provides a technology to improve such a problem. That is, a mesh is defined for every map scale. In the wide area display, a larger or coarser mesh size is used; in contrast, in the detailed display, a smaller or finer mesh size is used. The reduction of processing load in the drawing is thereby expected to be realized.

Patent document 1: JP-2006-39014 A

The technology in Patent document 1 can decrease the processing load in the drawing. When the mesh size is made small or fine in the detailed display, depression and projection may appear in a road near the view point, and its periphery to the road. This may cause a disadvantage to deteriorate the visibility in comparison with the flat map.

In particular, in a map display apparatus for a vehicle such as a vehicular navigation system, an area near the view point is generally close to the present position of the vehicle. This may deteriorate visibility with respect to the road, which is the driver is going to run, or a peripheral state.

### SUMMARY OF THE INVENTION

It is an object to provide a map display technology to maintain reality of a bird's-eye view map and provide a user with better visibility in display.

As an example of the present invention, a method is provided for drawing a bird's-eye view map with a polygon generated using altitude information defined for each of meshes of map data and displaying the drawn bird's-eye view map in a display device. The method comprises: (ii) an altitude information acquiring step of acquiring altitude information defined for the each of meshes; and (ii) a drawing step of changing a use manner of the acquired altitude information based on a height position in a display window of the display device, and drawing a bird's-eye view map by generating polygons using the altitude information the use manner of which is changed based on the height position.

As an example of the present invention, a map display apparatus is provided as follows. A map data storage device is configured to store map data including altitude information defined for each of meshes. A drawing section is configured to acquire the altitude information defined for the each of meshes of the map data stored in the map data storage device, and draw a bird's-eye view map with a polygon generated using the acquired altitude information for the each of meshes. A display device is configured to display a bird's-eye view map drawn by the drawing section. Herein, the drawing section is further configured to change a use manner of the altitude information based on a height position in a display window of the display device, and drawing a bird's-eye view map by generating polygons using the altitude information the use manner of which is changed based on the height position.

As an example of the present invention, a navigation system for a vehicle is provided as follows. A position detection device is configured to detect a present position of the vehicle. The above map display apparatus is included. Herein, the drawing section of the map display apparatus is further configured to draw a bird's-eye view map by using the map data of a predetermined area surrounding the present position of the vehicle.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a configuration of an in-vehicle navigation system according to an embodiment of the present invention;

FIG. 2 is a flowchart illustrating a process for drawing a bird's-eye view map;

FIG. 3 is an example of a display widow;

FIG. 4 is a diagram illustrating a method for integrating meshes;

FIGS. 5A, 5B are diagrams illustrating relations between (i) a view point for drawing a bird's-eye view map and (ii) an altitude;

FIG. 6 is a block diagram of a configuration for distributed processing in a control device of the navigation system.

### DETAILED DESCRIPTION OF THE PREFERRED EMBODIMENTS

An embodiment according to the present invention will be explained with reference to drawings. In addition, the embodiment of the present invention can be modified in various manners within a technical scope of the present invention without being limited to the following embodiments.

### First Embodiment

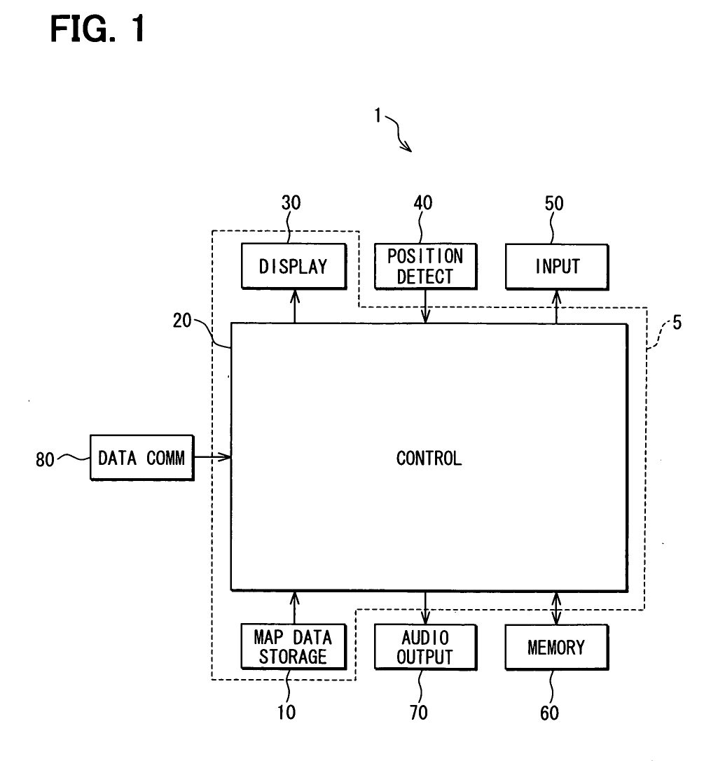

FIG. 1 is a block diagram showing a configuration of an in-vehicle navigation system according to an embodiment of the present invention. The navigation system 1 is mounted in a subject vehicle and includes the following: a map display apparatus 5, a position detection device 40, an input device 50, a memory 60, an audio output device 70, and a data communication device 80.

The map display apparatus 5 includes a map data storage device 10, a control device 20, and a display device 30. The map data storage device 10 stores map data including altitude information defined for each of meshes. The map data storage device 10 includes a CD-ROM, a DVD-ROM, a memory card, or a HDD. In addition to the map data, the map data storage device 10 further stores the various data containing map matching data for improving an accuracy of positioning and landmark data.

The display device 30 displays a bird's-eye view map drawn by the control device 20. Further, the display device 30 displays a map or a destination selection menu window, etc. The display device 30 can display full colors and includes a liquid crystal display, an organic electroluminescence display, etc.

The position detection device 40 includes the following known sensors or the like (none shown): a geomagnetic sensor, a gyroscope, a distance sensor, and a GPS receiver for GPS (Global Positioning System) which detects a present position of the vehicle based on electric waves from satellites.

The individual sensors or the like have different types of detection errors from each other; therefore, they are used to complement each other. In addition, part of the sensors or the like may be used depending on the required detection accuracy or each sensor's detection accuracy. Further, another sensor or the like such as a revolution sensor of steering and a wheel sensor of a following wheel may be used.

The input device 50 can be also called a switch information input device to include a touch switch (e.g., a touch sensitive panel switch) or mechanical switch etc. integrated in the display device 30. The input device 50 is used to input to the control device 20 an instruction signal to operate or activate the various functions based on an operation by a user or operator. The various functions include, for instance, a map scale change, a menu display selection, a destination designation, a route retrieval, a route guidance start, a present position correction, a display window change, an audio volume control, etc.

In addition, a remote control terminal (or called a remote) can be substituted for the input device 50; thus, communications with the control device 20 can be made via the wireless communication method.

The memory 60 includes a ROM, RAM, etc. The ROM stores a program for navigation, while the RAM temporarily stores work memory of the program and map data acquired from the map data storage device 10.

The audio output device 70 includes a speaker and outputs sounds for guidance or explanation of display operations. The data communication device 80 has an intercommunication function to include, for example, a portable terminal such as a cellular phone or mobile phone. The data communication device 80 is detachably connected with the control device 20. Alternatively, the data communication device 80 may be provided as being not easily detached and attached with the control device 20.

The control device 20 includes a CPU and I/O (none shown), and executes the process required for navigation. The processes for navigation are listed in the following (a) to (h) among the processes executed by the control device 20.

(a) Input Process

Information is inputted. The information includes a destination, a passing point, a view position, a descending view angle, a display scale, etc., set via the input device 50.

(b) Map Data Acquisition Process

Map data, which are needed in other processes, are acquired from the map data storage device 10.

(c) Map Matching Process

The road is designated which the present position exists on. This is executed by using the road configuration data of the map data acquired from the map data storage device 10, the position information detected by the position detection device 40, etc. Thus designated road is stored in the memory 60 as the present position information.

(d) Route Calculation Process

An optimal route is calculated from a start point calculated as the present position by the map matching process or designated by a user to a destination designated by the user. The calculated optimal route is displayed on a map designated via the input device 50. The technique of automatically designating the optimal route uses, for instance, the known Dijkstra method.

(e) Route Guidance Process

A guidance point required to output guidance or contents of the guidance (e.g., turning right or left) are calculated based on the result of the route calculation process, the data of the configuration of the road stored in the map data, the position information on intersections or crossings, etc.

(f) Display Process

Images are displayed in the display device 30 based on an instruction signal from a display window management process or section. The images include a map of the present position, a schematic drawing of a highway, and an enlarged view of an intersection and its vicinity when approaching the intersection. In addition, the present position of the vehicle detected by the position detection device 40 is displayed as a present position mark on the display map in superimposition. Furthermore, an additional display of other information can be also displayed. The additional information includes, for instance, a present time and congestion information in addition to the present position and the optimal route.

Herein, a bird's-eye view map is used as a map displayed in the display device 30. The explanation for the bird's-eye view map drawing process is made later.

(g) Display Window Management Process

An instruction for drawing information to be displayed in the display device 30 is issued. Herein, for instance, the display window management process calculates (i) how to use (or a use manner of) the altitude information based on a height position in the display window or (ii) the number of integrated meshes. Based on the result of the calculation, an instruction for drawing is issued to the display process.

(h) Communication Control Process

The communication device 80 is moved to a state for intercommunication based on an instruction by a user via the input device 50 or an instruction periodically issued by the control device 20.

(Bird's-Eye View Map Drawing Process)

A use manner to use the altitude information is changed based on a height position in the display window of the display device 30. A bird's-eye view map is drawn by generating polygons using the altitude information changed based on the height position in the display window. The drawn bird's-eye view map is displayed in the display device 30.

When the bird's-eye view map is displayed, a bird's-eye view map, which may be called an original or first bird's-eye view map, is divided into multiple window sections in the height direction of the display window in the display device 30, and in each of the multiple window sections, altitude information corresponding to the each window section is used.

With respect to the multiple window sections divided in the height direction of the display window, a value of the altitude information used in a lower window section is changed as being smaller than (or decreased from) a value of the altitude information used in an upper window section. That is, the value of the altitude information is decreased as a display target goes from the upper window section to the lower window section. For instance, the display window is divided into three in the height direction. In the distant-range view of the uppermost (or top) window section, the display height of the mountain range is expressed by directly using (the value of) the altitude information on the map data as it is. In the middle window section, the display height of the mountain range is expressed by using 50% of (the value of) the altitude information of the map data. In the view close to the view point of the lowest window section, a mountain range is not expressed.

Further, with respect to the multiple window sections divided in the height direction of the display window, a mesh of map data used in an upper window section is designed as being coarser than a mesh of map data used in a lower window section. That is, the mesh of the map data used for drawing becomes coarser as the display target goes from a lower window section to a upper window section.

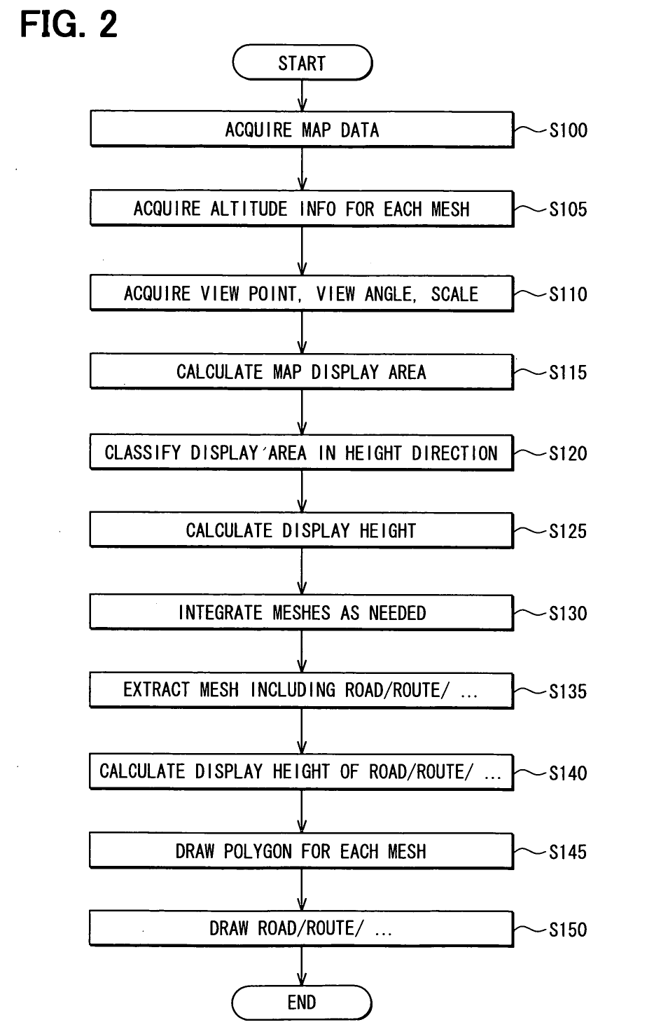

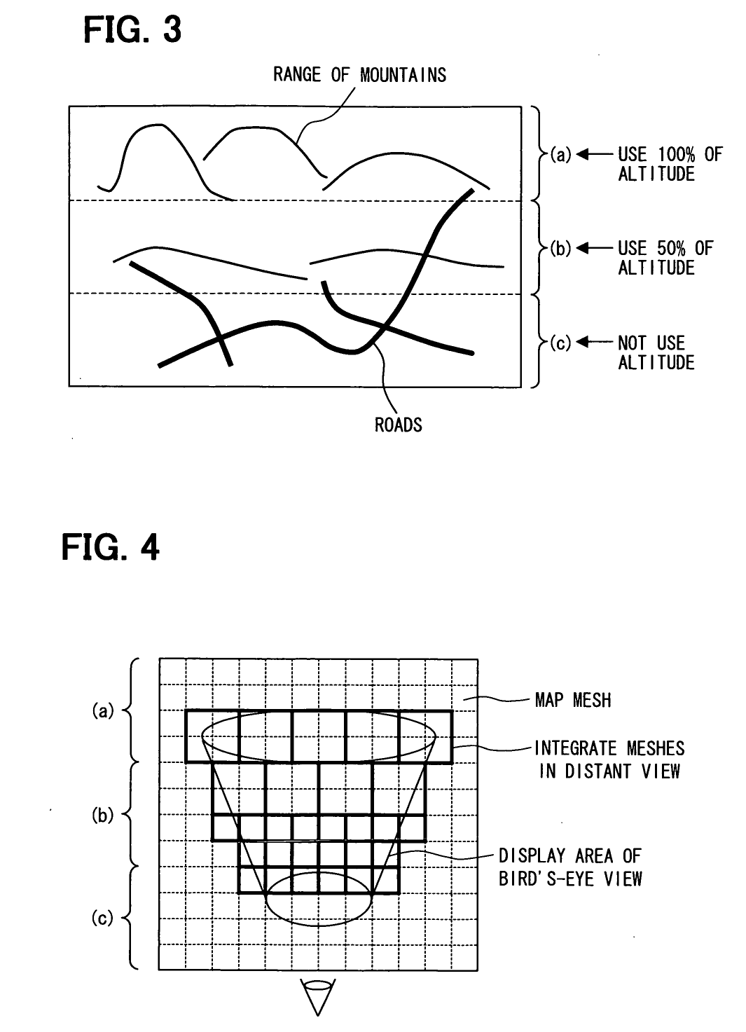

The bird's-eye view map drawing process is explained with reference to FIGS. 2, 3, and 4. FIG. 2 is a flowchart illustrating the bird's-eye view map drawing process. FIG. 3 is an example of the display window. FIG. 4 illustrates a method for integrating meshes of the map data.

In the bird's-eye view map drawing process, at S100, the map data is acquired from the map data storage device 10. At S105, the altitude information for every mesh is acquired from the map data acquired at S100.

At S110, the information on a view position, a descending view angle, and a display scale is acquired via the input device 50. At S115, a display area for the bird's-eye view map is acquired from the information acquired at S110. Thereafter, the processing advances to S120.

At S120, the display area for the bird's-eye view map is classified based on the height position in the display window. That is, the area of the bird's-eye view map acquired at S115 is divided into three window sections based on the height position in the display window. Among the three window sections, the window section corresponding to the highest portion (i.e., the top window section) is displayed in the top portion of the display window. The window section corresponding to the lowest portion (i.e., the bottom window section) is displayed in the bottom portion of the display window. The window section corresponding to the intermediate portion (i.e., the intermediate window section) is displayed in the intermediate portion of the display window.

At S125, a display height in the display window is calculated based on the altitude information for every display window section classified at S120. For instance, as illustrated in FIG. 3, among the three divided images in the corresponding window sections, the altitude information (i.e., the value of the altitude information) is used as being 100% (i.e., used as it is) in the image portion (a) in FIG. 3. The altitude information is used as being 50% (i.e., used as being halved) in the image portion (b) in FIG. 3. The altitude information is used as being zero (i.e., the altitude information is not used) in the image portion (c) in FIG. 3.

At S130, meshes are integrated for every display window section classified at S120. For instance, as shown in FIG. 4, among the meshes of the map data, the meshes are used as it is (or directly) in the image portion (c) in FIG. 3. In the top window section (a) in FIG. 4, mutually neighboring four meshes are integrated into a single mesh. In addition, in the intermediate window section (b) in FIG. 4, meshes in the lower portion are used as it is, while in the upper portion, the naturally adjoining four meshes are integrated into a single mesh for use.

At S135, a mesh containing information including a road, route, background, name, or mark is extracted. At S140, a display height in the display window of the information such as the road or the like included in the extracted mesh at S135 is calculated similar to at S125. The processing then advances to S145.

At S145, polygons are generated for individual meshes as having the display heights calculated at S125, and a bird's-eye view map, which may be called a revised or second bird's-eye view map, is drawn. At S150, the road, route, background, name, mark, etc. are drawn with the display height calculated at S140.

After drawing at S150, the processing is once ended. The processing again returns to S100 and the bird's-eye view map drawing process is repeated while the control device 20 is turned on.

(Feature of Vehicular Navigation System 1)

According to the above navigation system 1, the reality of the bird's-eye view map is maintained, and the good visibility of the display is attained for the user.

Assume the case that a bird's-eye view map is drawn using altitude information defined for each mesh of map data, If the bird's-eye view map is drawn using the altitude information of the fine uniform meshes over the whole display window, the distant-range view like a mountain range can be drawn with reality. In contrast, depression and projection appear in the road or periphery close to the view point. This may cause a disadvantage to deteriorate the visibility in comparison with the flat map.

The area close to the view point generally corresponds to a periphery to the present position of the subject vehicle. This may prevent the driver from easily seeing a road the vehicle is just going to run and the vicinity to the road. In contrast, according to the above navigation system 1, the use manner of the altitude information is changed based on the height position in the display window of the display device 30, and polygons are generated based on the changed altitude information, i.e., the altitude information the use manner of which is changed, to thereby draw a revised bird's-eye view map. Thus, the altitude information used for the bird's-eye view map can be changed between an upper portion and a lower portion of the display window in the display device 30.

As a result, the distant-range view can be displayed with reality;

the close-range view can be displayed similar to the flat map without significant depression and projection. Thus, the whole of the bird's-eye view image can be displayed with good visibility.

That is, the method of using the altitude information is changed based on the height position of the bird's-eye view map in the display window of the display device 30; the polygons are generated based on the changed altitude information to thereby draw a bird's-eye view map. Such a configuration can maintain the reality of the bird's-eye view map and provide a user with better visibility in display.

In the present embodiment, the bird's-eye view map has two horizontal divisions that divide the map or display window into three window sections in the height direction based on the height position in the display window. In each of the three window sections, altitude information corresponding to the each window section is used.

That is, in the top window section, the altitude information is used as being 100% (i.e., as it is). In the central or intermediate window section, the altitude information is used as being 50%. In the bottom window section, the altitude information is used as being 0% (i.e., not used). Among the multiple window sections divided in the height direction of the display window, a value of the altitude information used in a lower window section is changed as being smaller than (or decreased from) a value of the altitude information used in an upper window section (see FIG. 3).

For example, if an altitude of 100 m is decreased to one tenth ( 1/10) of 1 m as a display height, depression and projection in the close-range view can be not conspicuous.

Therefore, the altitude information can be used differently among the window sections located at the top, at the bottom, and at the center of the display window. The distant-range view can be expressed with reality. The closer-range view can be expressed with the depression and projection less conspicuous. As the whole, the bird's-eye view map can be smoothly changed from the upper to the lower in the display window and thus provided with the good visibility. In other words, the display of the display window can be prepared appropriately to meet the data contents of the bird's-eye view map.

In addition, the map data include meshes which are uniform in fineness. However, with respect to the multiple window sections, a mesh of map data used in an upper window section is designed to be coarser than a mesh of map data used in a lower window section. Therefore, the close-range view drawn in a lower window section is finer than the distant-range view drawn in an upper window section. Users can be thus provided with a bird's-eye view map having enhanced visibility.

In addition, since the mesh is coarser in the distant-range view, the points to be calculated for drawing decrease in number. This can provide another advantage to decrease the processing load in drawing.

### Second Embodiment

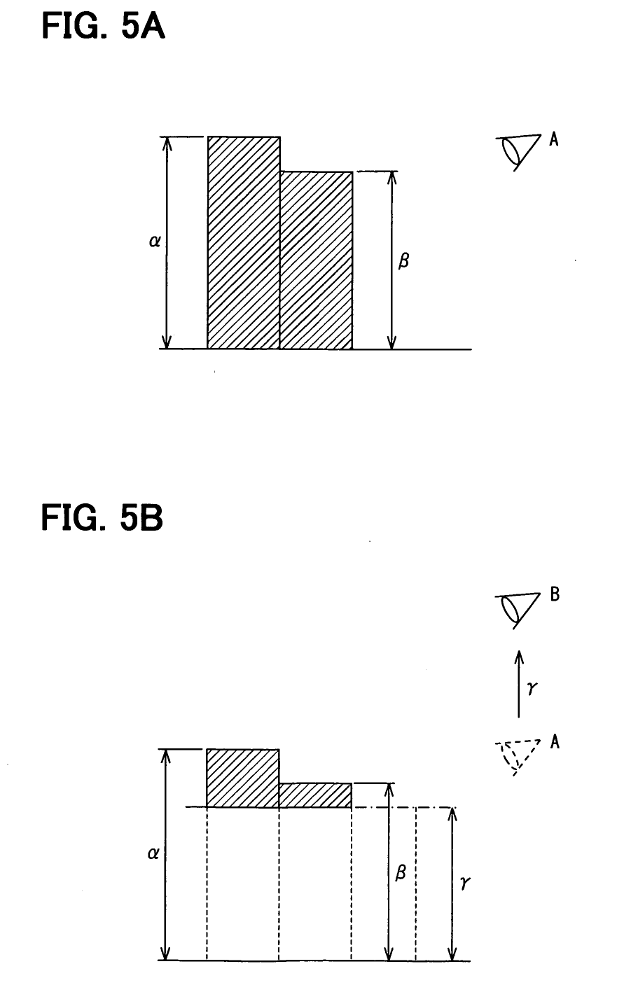

A second embodiment is explained with reference to FIGS. 5A, 5B. In the second embodiment, a reference value or reference altitude is used which is calculated based on the altitude information defined for each mesh of a predetermined area acquired from the map data storage device 10. FIGS. 5A, 5B illustrate a relation between (i) a view position for drawing a bird's-eye view and (ii) an altitude of a display target.

In the second embodiment, the configuration of the navigation system is the same as that of the first embodiment; thus, explanation of the configuration is omitted. In addition, the process executed by the control device 20 is almost the same as that of the first embodiment; thus, the same part is omitted from the explanation and only the different part is explained below.

In the navigation system of the second embodiment, S123 is inserted between S120 and S125 in the bird's-eye view map drawing process. At S123, the altitude information (i.e., values of altitudes) in the map display area calculated at S115 is averaged to thereby define a reference value or altitude of the map display area.

At S125, an altitude (or a value of the altitude information) used for display, which is called a display height, is calculated from the altitude information for every display window section classified. Herein, with respect to a portion higher than the reference altitude calculated at S123, the reference altitude or value is subtracted from the altitude information to thereby obtain a display height used for display.

For instance, with reference to FIG. 5A, original values of altitude information in a display area are illustrated as α and β. In the second embodiment, with reference to FIG. 5B, the reference altitude of a value of γ is subtracted from the values of α and β to thereby each display height.

Thus, with respect to the portion whose altitude is higher than the reference altitude, the bird's-eye view image is displayed using the value obtained after the subtraction of the reference altitude from the original altitude information. As a result, the resultant display heights are illustrated in the shaded areas of FIG. 5B. Herein, the view point is offset by the reference altitude (γ) to thereby move from the position (illustrated as A) to the position (illustrated as B). Thus, the bird's-eye view map can be expressed such that the altitude can be illustrated as appearing natural not directly based on the altitude of the display point.

For instance, assume the case that in an upland area, a bird's-eye view map for covering a periphery is displayed on the display window. If the bird's-eye view map is displayed using the altitude information as it is, the displayed images of the display window may be extremely differentiated between the forward area and the backward area of the bird's-eye view map. The second embodiment can solve such a problem.

### Other Embodiments

(1) In the above embodiments, the bird's-eye view map is divided into three window sections in the height direction of the display window. It may be divided into two window sections. Herein, the altitude information may be used as it is in the upper window section while none of the altitude information may be used in the lower window section. Such a configuration may increase a unnaturalness of the whole map but can decrease the processing load in the bird's-eye view map drawing process.

(2) In the above embodiments, with respect to the multiple window sections of the display window, the meshes used for drawing images in an upper window section are coarser than those used in a lower window section. Another configuration may be adopted. That is, the meshes used for drawing images in a lower window section are finer than those used in an upper window section.

That is, the navigation system may have multiple types of meshes of the map data. The fine mesh may be used in the bottom window section among the multiple window sections. The coarse mesh may be used in an upper window section. The close-range view is thereby drawn by using the finer mesh than the distant-range view. The bird's-eye view map more useful for uses can be drawn. Furthermore, since the mesh of the distant-range view is coarse, the processing load can be reduced.

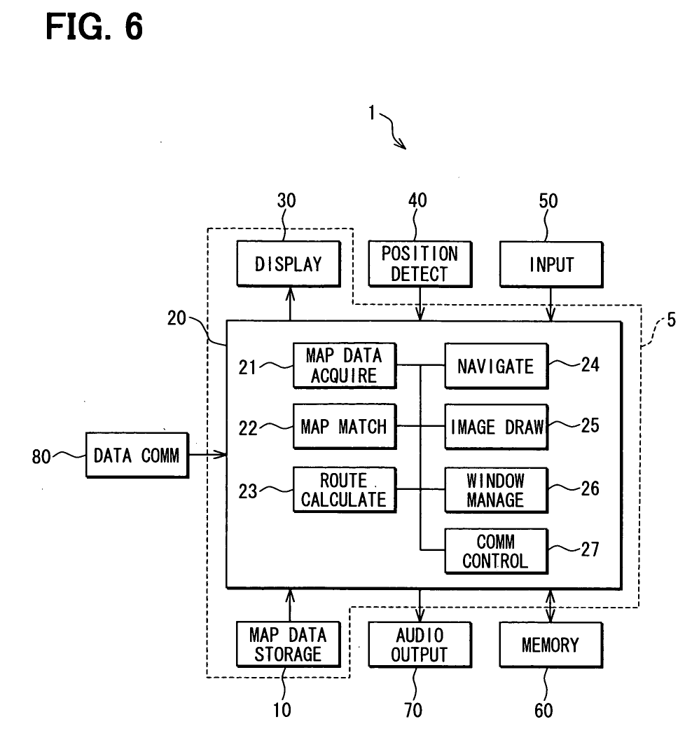

(3) In the above embodiments, each process by the control device 20 is executed by a single CPU. As illustrated in FIG. 6, the processes may be executed by multiple CPUs or DSPs (Digital Signal Processors) connected with each other via a bus line. FIG. 6 is a block diagram of a configuration for distributed processing in the control device 20.

That is, a map data acquisition section 21 of the control device 20 may execute a map data acquisition process. A map matching section 22 may execute a map matching process. A route calculation section 23 may execute a route calculation process. A route guidance section or navigation section 24 may execute a route guidance process. A display control section or image drawing section 25 may execute a display process. A display window management section 26 may execute a display window management process. A communication control section 27 may execute a communication control process. Further, the input device 50 may execute an input process. The above configuration allows distributed processing of each process to thereby increase the processing speed. The displaying speed of the bird's-eye view map becomes quick: thus, the map display is executed smoothly.

Each or any combination of processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A method for displaying a map to draw a bird's-eye view map with a polygon generated using altitude information defined for each of meshes of map data and display the drawn bird's-eye view map in a display device,
the method comprising:
an altitude information acquiring step of acquiring altitude information defined for the each of meshes;
a drawing step of changing a use manner of the acquired altitude information based on a height position in a display window of the display device, and drawing a bird's-eye view map by generating polygons using the altitude information the use manner of which is changed based on the height position.

2. The method according to claim 1, wherein
at the drawing step,
(i) the bird's-eye view map is divided in a height direction of the display window into multiple window sections and (ii) in each of the multiple window sections, altitude information corresponding to the each window section is used.

3. The method according to claim 2, wherein
at the drawing step,
(i) the bird's-eye view map is divided into two window sections including an upper window section and a lower window section in the height direction of the display window, and (ii) in the upper window section, the altitude information is used as it is while in the lower window section, none of the altitude information is used.

4. The method according to claim 2, wherein
at the drawing step,
with respect to the multiple window sections divided in the height direction of the display window, a value of the altitude information used in a lower window section is decreased more than a value of the altitude information used in an upper window section.

5. The method according to claim 1, further comprising:
a calculating step of calculating a reference value, which is a reference for a display height in the display window, based on the altitude information defined for the each of meshes included in a predetermined area,
wherein at the drawing step,
when drawing a bird's-eye view map in a portion having a higher value of the altitude information than the reference value, the bird's-eye view is drawn using a value as a result of subtraction of the reference value from the higher value of the altitude information.

6. The method according to claim 2, wherein
at the drawing step,
with respect to the multiple window sections divided in the height direction of the display window, a mesh of map data used in a lower window section is finer than a mesh of map data used in an upper window section.

7. The method according to claim 2, wherein
at the drawing step,
with respect to the multiple window sections divided in the height direction of the display window, a mesh of map data used in an upper window section is coarser than a mesh of map data used in a lower window section.

8. A map display apparatus comprising:
a map data storage device configured to store map data including altitude information defined for each of meshes;
a drawing section configured to acquire the altitude information defined for the each of meshes of the map data stored in the map data storage device, and draw a bird's-eye view map with a polygon generated using the acquired altitude information for the each of meshes; and
a display device configured to display a bird's-eye view map drawn by the drawing section,
wherein the drawing section is further configured to change a use manner of the altitude information based on a height position in a display window of the display device, and drawing a bird's-eye view map by generating polygons using the altitude information the use manner of which is changed based on the height position.

9. The map display apparatus according to claim 8, wherein
the drawing section is further configured to (i) divide the bird's-eye view map in a height direction of the display window into multiple window sections and (ii) use, in each of the multiple window sections, altitude information corresponding to the each window section.

10. The map display apparatus according to claim 9, wherein
the drawing section is further configured to divide the bird's-eye view map in a height direction of the display window into two window sections including an upper window section and a lower window section, and use the altitude information in the upper window section as it is while using none of the altitude information in the lower window section.

11. The map display apparatus according to claim 9, wherein
with respect to the multiple window sections divided in the height direction of the display window, the drawing section is further configured to use the altitude information such that a value of the altitude information used in a lower window section is decreased more than a value of the altitude information used in an upper window section.

12. The map display apparatus according to claim 8, wherein:
the drawing section is further configured to calculate a reference value, which is a reference for a display height in the display window, based on the altitude information defined for the each of meshes included in a predetermined area; and
when drawing a bird's-eye view in a portion having a higher value of the altitude information than the reference value, the bird's-eye view is drawn using a value as a result of subtraction of the reference value from the higher value of the altitude information.

13. The map display apparatus according to claim 9, wherein
with respect to the multiple window sections divided in the height direction of the display window, the drawing section is further configured to use the altitude information such that a mesh of map data used in a lower window section is finer than a mesh of map data used in an upper window section.

14. The map display apparatus according to claim 9, wherein
with respect to the multiple window sections divided in the height direction of the display window, the drawing section is further configured to use in an upper window section a mesh of map data coarser than a mesh of map data used in a lower window section.

15. A navigation system for a vehicle, the system comprising:
a position detection device configured to detect a present position of the vehicle; and
the map display apparatus according to claim 8,
wherein the drawing section of the map display apparatus is further configured to draw a bird's-eye view map by using the map data of a predetermined area surrounding the present position of the vehicle.
